(19) United States
(12) Patent Application Publication
(10) Pub. No.: US 2003/0008671 A1
(43) Pub. Date: Jan. 9, 2003

(54) Method and apparatus for providing local orientation of a GPS capable wireless device

(75) Inventors: David A. Lundgren, Mill Valley, CA (US); Frank van Diggelen, San Jose, CA (US)

Correspondence Address: Moser, Patterson & Sheridan, LLP, Attorneys At Law, Suite 100, 595 Shrewsbury Avenue, Shrewsbury, NJ, 07702, US

(73) Assignee: Global Locate, Inc.

(21) Appl. No.: 10/186,200

(22) Filed: Jun. 28, 2002

Related U.S. Application Data
(60) Provisional application No. 60/303,385, filed on Jul. 6, 2001.

(51) Int. Cl. G01S 1/00; H04B 7/185; G01S 3/02; H04Q 7/20

(52) U.S. Cl. 455/456; 455/457; 342/357.08; 342/357.09; 342/450

(57) ABSTRACT

A wireless device having position location capabilities that are further enhanced by circuitry that enables the wireless device to compute its local orientation. The wireless device includes a wireless transceiver subsystem, a position location receiver subsystem, a central processing unit (CPU), a memory, and a user interface. The CPU is coupled to local orientation data sensors that provide information regarding the local orientation of the device. The device orientation and position of the wireless device is used to identify certain information that is requested by the device. The information is then displayed to the user at the remote device.

### CROSS-REFERENCE TO RELATED APPLICATIONS

This application claims benefit of U.S. provisional patent application serial No. 60/303,385, filed Jul. 6, 2001, which is herein incorporated by reference.

### BACKGROUND OF THE INVENTION

1. Field of the Invention

The present invention generally relates to wireless devices that are enhanced with position location capabilities. More particularly, the invention relates to a method and apparatus for providing local orientation processing to a wireless device having position location capabilities.

2. Description of the Related Art

Positioning systems such as the global positioning system (GPS) have fostered numerous applications that involve tracking people and assets with devices that communicate to a network over wireless links. Various systems provide periodic location of a fixed asset, notification of proximity to pre-requested services, on-demand location identification, or continuous tracking of the location of a person or asset. Such systems provide an absolute definition of a user's position (i.e., latitude, longitude, nearest cross streets, dot position on a map, and so on), but do not orient a user as to the direction they are facing or traveling. The presently available systems also do not provide orientation with respect to a direction relative to the user such that the user may identify locations, persons or assets that are nearby.

Therefore, there is a need in the art for a method and apparatus that provides local orientation to users of wireless devices having position location capabilities.

### SUMMARY OF THE INVENTION

The present invention is a wireless device having position location capabilities that is further enhanced by circuitry that enables the wireless device to compute its local orientation. The wireless device of the present invention comprises a wireless transceiver subsystem, a position location receiver subsystem, a central processing unit (CPU), a memory, and a user interface. The CPU is coupled to local orientation sensors that provide information regarding the local orientation of the device. The CPU, when executing software stored in the memory, will process position location signals as well as signals from the wireless transceiver to identify the location of the device. In addition, orientation data is processed to provide the device's local orientation. When a user requests information regarding the user's location and orientation, the device orientation is transmitted to a location server within a wireless communication system. The location server identifies certain information that is requested by the device and transmits that information based on the location of the device as well as the orientation of the device. The information received from the location server is then displayed to the user at the wireless device.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of the position location enabled wireless device having local orientation capabilities; and

FIG. 2 is a flow diagram of the operation of the device of FIG. 1.

### DETAILED DESCRIPTION OF THE INVENTION

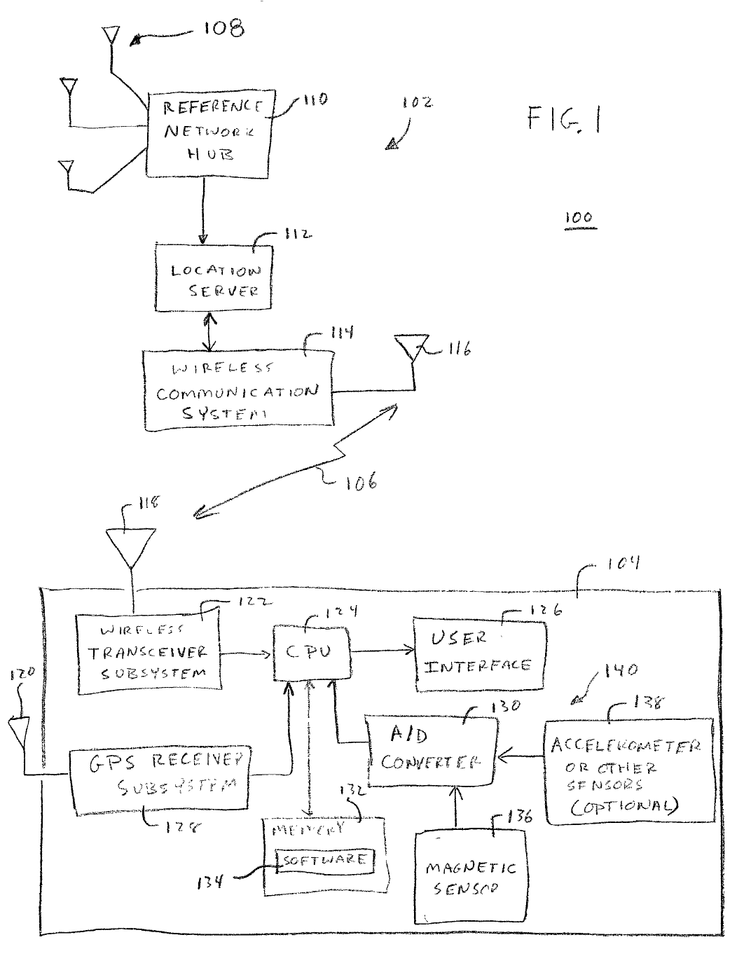

FIG. 1 depicts a block diagram of a position location aided wireless communication system 100 comprising a position location aiding system 102 and a remote wireless device 104. The system 102 comprises an array of reference stations 108 positioned around the globe. The reference stations are coupled to the reference network 110, which collects the satellite position information for all the satellites in a constellation and sends that information to a location server 112. The location server is coupled to a wireless communication system 114 such as a cellular telephone system. The wireless communication system 114 communicates with a plurality of wireless devices (for example, device 104) via antenna 116. Operation of the reference network system is described in commonly assigned U.S. Pat. No. 6,411,892, issued Jun. 25, 2002, which is incorporated herein by reference. This network system 102 provides position location services to the device 104 such that the device can request its position from the location server 112.

The wireless communication system 114 is coupled to the remote wireless device 104 via a wireless communications link 106. The remote device 104 comprises a conventional wireless transceiver subsystem 122 and a conventional position location receiver subsystem 128. The position location receiver subsystem 128 is, for example, a global positioning system (GPS) receiver subsystem. Those skilled in the art will realize that any position location receiver subsystem may function in this device, including, receiver subsystems for such satellite-based position location systems as GLONASS and GALILEO. The invention is described below with respect to the GPS position location system.

The GPS receiver subsystem 128 is coupled to a GPS antenna 120 for receiving satellite signals from the GPS satellites (not shown). GPS receiver subsystem provides all of the well-known front-end functionality as well as the correlation functions of a GPS receiver. The output of the GPS receiver subsystem 128 and the output of the wireless transceiver subsystem 122 are coupled to a central processing unit 124. The central processing unit is supported by user interface 126 and a memory 132. The memory 132 stores software 134 that is executed by the CPU 124 to facilitate operation of the remote wireless device 104.

The remote device 104 is enhanced by orientation circuits 140 that are used to provide orientation information to the CPU 124. In one embodiment, the orientation circuits 140 comprise a magnetic sensor 136, an analog-to-digital (A/D) converter 130 and, optionally, an accelerometer or other sensors 138. The analog signals from the sensors 136 and 138 are digitized in the A/D converter 130 and are coupled to the CPU 124.

The magnetic sensor 136 is generally a 2-axis magnetometer. Alternatively, a 3-axis magnetometer may be used. The magnetic sensor 136 provides data corresponding to the orientation of the device 104 with respect to the earth's magnetic field. As such, the device's orientation with respect to magnetic north is always known. By referencing magnetic north to True north (e.g., by using look-up tables stored in memory 132), the orientation of the remote device 104 with respect to True north can be determined. The accelerometer circuits 138 provide acceleration information with regard to the movement of the remote device 104.

Information from the local orientation circuits 140 can be used to provide local orientation of the remote device 104. For example, the magnetic sensor 136 can provide information as to the number of degrees from north (i.e., either True north or magnetic north) the remote device 104 is facing. Given the position of the remote device 104 and the position of a target, the output of the magnetic sensor 136 can be used to determine the direction of the target relative to the current heading of the remote device 104 (i.e., local orientation of the remote device relative to the target). As described below, outputs from the GPS receiver subsystem 128 and location server 112 can be used to determine the distance from the remote device 104 to the target. The remote device 104 can then display the local orientation and distance information as, for example, an arrow on a screen indicating the required direction and distance of travel. In addition, output from the accelerometer or other sensors 138 can be used to update the local orientation information and distance information as the remote device 104 travels towards the target.

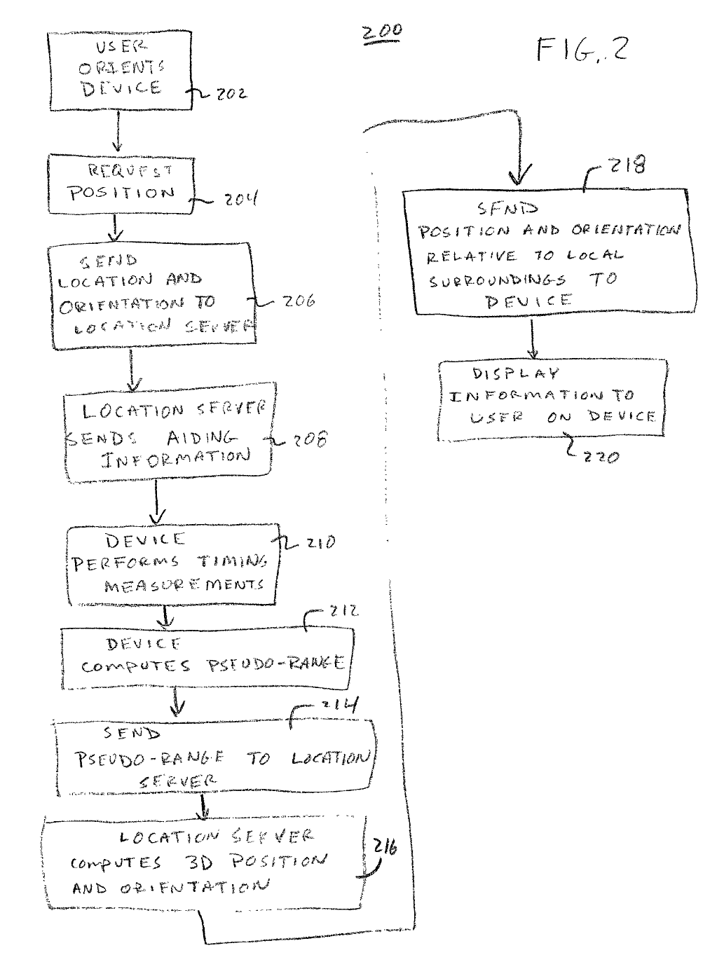

FIG. 2 depicts a flow diagram of a method 200 of operation of the remote device 104. The method 200 begins with step 202 in which the user “orients” the device 104. To orient the device, the user points the device in any direction and makes a request for information as to a direction and a location (e.g., where is my car?). The request may take the form of simply pointing the remote device 104 in a particular direction and pushing a button such that the magnetic sensor and accelerometer information is “locked in” and used by the CPU 124. More advanced remote devices 104 may use a keypad input, a touch screen input, or a voice activated interface for the user to request the information.

At step 204, the device 104 requests the location of the device from the location server 112. At step 206, the device 104 sends the estimated location of the device as well as its orientation to the location server 112. The estimated location is generally identified by a cellular telephone “cell”, or wireless base station, through which the device 104 is communicating. The estimated location and orientation data are sent through the wireless transceiver 122 and its associate antenna 118 to the wireless communication system 114. At the wireless communication system, the location and orientation information is coupled to the location server 112 where it is used to extract certain satellite data regarding the position of the remote device 104.

At step 208, the location server 112 sends this position information, typically the ephemeris data or other satellite tracking data that is collected by reference network, through the wireless communication system 114 to the wireless transceiver subsystem 122 and, finally, to the CPU 124 for processing. At step 210, the device 104 performs well-known timing measurements with respect to the satellite signals received by the GPS receiver subsystem 122. At step 212, the device 104 computes the pseudo-range data or information with regard to the satellites that are in view of the GPS receiver subsystem 122.

At step 214, the device 104 sends the pseudo-range information to the location server 112 via the wireless communication system 114. Alternatively, the device 104 computes its position and sends the position to the location server 112. At step 216, the location server computes a three dimensional position of the remote device 104 and its orientation with respect to the user and the user's environment. At step 218, the location server sends the position and the orientation relative to the local surroundings to the device 104. In an alternative embodiment, the remote device 104 computes its three dimensional position and orientation with respect to the user and the user's environment, rather than the location server 112. In such an embodiment, the remote device 104 stores information relating to the user's environment in the memory 132. At step 220, the device 104 displays the information to the user on a user interface 126.

One application for the device 104 would be used indoors in a shopping mall, for example, where the user may seek direction to a specific location such as where their car is parked, or where a particular store is located within the shopping mall. In such a situation, compass based directions, north, south, east, west, are not especially useful, since a user may have no idea in which direction north is located. With the device 104 or the present invention, however, a user can point the wireless device in any direction and press a button or otherwise command the device to “orient” relative to that direction. The location server 112 would receive the information relative to the orientation and return to the user directions based on their orientation. Such directions may be “Move 200 paces to your right, take a left, and then 100 paces forward” to reach the requested destination. To aid the user in understanding their location and how to get to the location that they desire, graphical representations could be sent through a wireless Internet application to be displayed on the user interface (e.g., a map of the mall having a travel path overlay).

A similar application could arise where a user operating the device 104 on a city street or an urban canyon, especially at night or in inclement weather, would point the device down the street where there is limited visibility and the system would return to the user information on how to navigate locally to a destination that is out of their line of sight.

Additionally, the invention has application as a system using more than one wireless GPS enabled device. For example, if a parent had a GPS enabled wireless device (e.g., a cell phone) having the local orientation capability of the present invention, the device could receive navigational instructions as to the whereabouts of a child that is carrying a smaller, simpler tracking device. Location information could be sent from the tracking device to either the location server 112 or the cell phone, depending on which is computing the local orientation of the cell phone with respect to the tracking device, and the distance from the cell phone to the tracking device. As described above, either the location server 112 or the remote device 104 can compute three dimensional position and local orientation of the remote device 104. In any case, the cell phone could display an arrow and/or distance (e.g., child is one hundred yards behind you to your left in a shopping mall), a map showing the position of the child, or an audible range finder signal.

While the foregoing is directed to the preferred embodiment of the present invention, other and further embodiments of the invention may be devised without departing from the basic scope thereof, and the scope thereof is determined by the claims that follow.

1. Apparatus providing a local orientation to a position location enabled wireless device comprising:
a location server for providing position location information to a plurality of remote wireless devices; and
at least one remote wireless device comprising local orientation circuits for identifying an orientation of the remote device, and a wireless subsystem for communicating the orientation to the location server.

2. The apparatus of claim 1 further comprising a reference network system for providing position information to the location server.

3. The apparatus of claim 1 wherein said at least one remote wireless device comprises a position location receiver.

4. The apparatus of claim 1 wherein said orientation circuits comprise a magnetic sensor.

5. The apparatus of claim 4 wherein the magnetic sensor is a magnetometer.

6. The apparatus of claim 1 wherein the orientation circuits include an accelerometer.

7. The apparatus of claim 1 wherein the remote wireless device comprises a position location receiver subsystem for processing received satellite signals and the position location information supplied by the location server.

8. The apparatus of claim 1 further comprising a display for displaying information to a user.

9. A method of providing local orientation to a position location enabled wireless device comprising:
orienting the device;
transmitting a request for position and orientation related information from the device to a location server;
transmitting, in response to the request, position location information from the location server to the device;
processing the position location information and received satellite signals to compute a position of the device;
transmitting the device orientation to the location server;
identifying, within the location sever, information related to the position and orientation of the device; and
transmitting the information to the device for display.

10. The method of claim 9 wherein the step of processing comprises:
producing a plurality of pseudo-ranges within the device using the position location information from the location server and the received satellite signals;
transmitting the plurality of pseudo-ranges to the location server;
computing, within the location server, the position of the device; and
transmitting the device position to the device.

11. The method of claim 9 wherein the position of the device is computed within the device using the position location information and the received satellite signals.

12. The method of claim 9 wherein the location server receives position information from a reference network system.

13. The method of claim 9 wherein the step of orienting the device comprises determining the orientation of the device using a magnetic sensor.

14. The method of claim 9 wherein the step of orienting the device comprises determining the acceleration of the device using an accelerometer.

15. A method of providing local orientation to a position location enabled wireless device comprising:
orienting the device;
transmitting a request for position information from the device to a location server;
transmitting, in response to the request, position location information from the location server to the device;
processing the position location information and received satellite signals to compute a position of the device; and
identifying, within the mobile device, information related to the position and orientation of the device for display.

16. The method of claim 15 wherein the step of processing comprises:
producing a plurality of pseudo-ranges within the device using the position location information from the location server and the received satellite signals;
transmitting the plurality of pseudo-ranges to the location server;
computing, within the location server, the position of the device; and
transmitting the device position to the device.

17. The method of claim 15 wherein the position of the device is computed within the device using the position location information and the received satellite signals.

18. The method of claim 15 wherein the location server receives position information from a reference network system.

19. The method of claim 15 wherein the step of orienting the device comprises determining the orientation of the device using a magnetic sensor.

20. The method of claim 15 wherein the step of orienting the device comprises determining the acceleration of the device using an accelerometer.
